(19) United States
(12) Patent Application Publication
(10) Pub. No.: US 2010/0141608 A1
(43) Pub. Date: Jun. 10, 2010

(54) Index Matching For Touch Screens

(76) Inventors: Lili HUANG, San Jose, CA (US); Shih Chang Chang, Cupertino, CA (US); Neal Oldham, San Jose, CA (US); Steve Porter Hotelling, San Jose, CA (US); John Z. Zhong, Cupertino, CA (US); Chun-Hao Tung, Tapei City (TW)

Correspondence Address: APPLE C/O MORRISON AND FOERSTER ,LLP;LOS ANGELES, 555 WEST FIFTH STREET SUITE 3500, LOS ANGELES, CA, 90013-1024, US

(21) Appl. No.: 12/331,430

(22) Filed: Dec. 9, 2008

(51) Int. Cl. G06F 3/041

(52) U.S. Cl. 345/178

(57) ABSTRACT

Index matching for touch screens is provided. An index matching stackup for a touch screen can be formed including a substantially transparent substrate, a substantially transparent conductive layer disposed in a pattern, and an index matching layer for improving an optical uniformity of the touch screen. The index matching layer can also be designed to operate as a dual-function layer. In one dual-function design, the index matching layer design performs both index matching and passivating the conductive layer. In another dual-function design, the index matching layer performs both index matching and adhesion of layers. The index matching layer can also be designed to serve all three functions of index matching, passivating, and adhering.

### FIELD OF THE INVENTION

This relates generally to index matching, and more particularly, to index matching a patterned layer of substantially transparent conductive material layer of a touch screen.

### BACKGROUND OF THE INVENTION

Many types of input devices are presently available for performing operations in a computing system, such as buttons or keys, mice, trackballs, joysticks, touch sensor panels, touch screens and the like. Touch screens, in particular, are becoming increasingly popular because of their ease and versatility of operation as well as their declining price. Touch screens can include a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

Mutual capacitance touch sensor panels typically include a matrix of drive lines and sense lines formed of a substantially transparent conductive material, such as Indium Tin Oxide (ITO). The substantially transparent drive and sense lines are often arranged in rows and columns in horizontal and vertical directions on a substantially transparent substrate, such as silicon dioxide (SiO₂). However, even though the conductive layer of patterned lines is substantially transparent, the lines typically can still be seen, and the visible pattern of the lines can be distracting to a user.

### SUMMARY OF THE INVENTION

In view of the above, index matching for touch screens is provided. An index matching stackup can include a substantially transparent substrate, a substantially transparent conductive layer disposed in a pattern, and an index matching layer. The index matching layer can also be designed to operate as a dual-function layer. In one dual-function design, the index matching layer design can perform both index matching and passivating the conductive layer. In another dual-function design, the index matching layer can perform both index matching and adhesion of layers. The index matching layer can also be designed to serve all three functions of index matching, passivating, and adhering. In one approach, the index of refraction of matching layer can be tuned to closely match the index of refraction of the patterned ITO layer. In another approach, the index of refraction of the matching layer can be tuned to help form a stack of layers whose indices of refraction are a decreasing gradient that approaches the index of refraction of air (i.e., 1) at the surface of the touch screen, thus making it more difficult for the human eye to distinguish the individual layers of different indices of refraction.

### BRIEF DESCRIPTION OF THE DRAWINGS

FIG. 1 illustrates an example non-uniform patterned conductive trace layer.

FIG. 2a illustrates an example mutual capacitance touch sensor panel according to embodiments of the invention.

FIG. 2b illustrates an example pixel in a steady-state (no-touch) condition according to embodiments of the invention.

FIG. 2c illustrates an example pixel in a dynamic (touch) condition according to embodiments of the invention.

FIG. 3 illustrates an example computing system that can include one or more of the embodiments of the invention.

FIG. 4 illustrates an example conductive trace layer of patterned ITO formed on a glass substrate.

FIG. 5 illustrates an example method of reducing the visibility of a patterned ITO layer of a touch screen according to embodiments of the invention.

FIG. 6 illustrates another example method of reducing the visibility of a patterned ITO layer of a touch screen according to embodiments of the invention.

FIG. 7 illustrates an example computer simulation model directed to the embodiment illustrated in FIG. 6.

FIG. 8 illustrates another example method of reducing the visibility of a patterned ITO layer of a touch screen according to embodiments of the invention.

FIG. 9 illustrates an example double-sided ITO (DITO) stackup of a touch screen according to embodiments of the invention.

FIG. 10 illustrates an example single-layer ITO (SITO) stackup of a touch screen according to embodiments of the invention.

FIG. 11a illustrates an example mobile telephone having a touch sensor panel that can include an index matching stackup according to embodiments of the invention.

FIG. 11b illustrates an example digital media player having a touch sensor panel that can include an index matching stackup according to embodiments of the invention.

FIG. 11c illustrates an example personal computer having a touch sensor panel (trackpad) and/or display that can include an index matching stackup according to embodiments of the invention.

### DETAILED DESCRIPTION

In the following description, reference is made to the accompanying drawings which form a part hereof, and in which it is shown by way of illustration specific example embodiments in which the invention can be practiced. It is to be understood that other embodiments can be used and structural changes can be made without departing from the scope of the invention.

This relates to index matching a patterned layer of substantially transparent conductive material layer of a touch screen for improving an optical uniformity of the touch screen by reducing the visibility of the pattern. The index matching may also reduce the reflectance of the touch screen. The visibility of these patterns may be reduced through the application of one or more index matching material layers. The material or materials applied can be selected based upon their refractive index properties. In one approach, the index of refraction of matching layer can be tuned to closely match the index of refraction of the patterned ITO layer. In another example, the index of refraction of the matching layer can be tuned to help form a stack of layers whose indices of refraction are a decreasing gradient that approaches the index of refraction of air (i.e., 1) at the surface of the touch screen, thus making the individual layers of different indices of refraction more difficult for the human eye to see. In addition, by properly selecting the material used to form the index matching layer, the index matching layer can also serve as a passivation layer for the conductive trace layer. Likewise, by properly selecting the material of the index matching layer, the index matching layer can also serve to adhere the conductive trace layer to another layer.

Although embodiments of the invention may be described and illustrated herein in terms of mutual capacitance touch sensor panels, it should be understood that embodiments of this invention are not so limited, but are additionally applicable to self-capacitance sensor panels, and both single and multi-touch sensor panels in which the fabrication of conductive traces is required. Furthermore, although embodiments of the invention may be described and illustrated herein in terms of single-layer ITO (SITO) touch sensor panels, it should be understood that embodiments of the invention are also applicable to materials other than ITO and other touch sensor panel configurations, such as configurations in which the drive and sense lines are formed on different substrates or on the back of a cover glass, and configurations in which the drive and sense lines are formed on opposite sides of a single substrate.

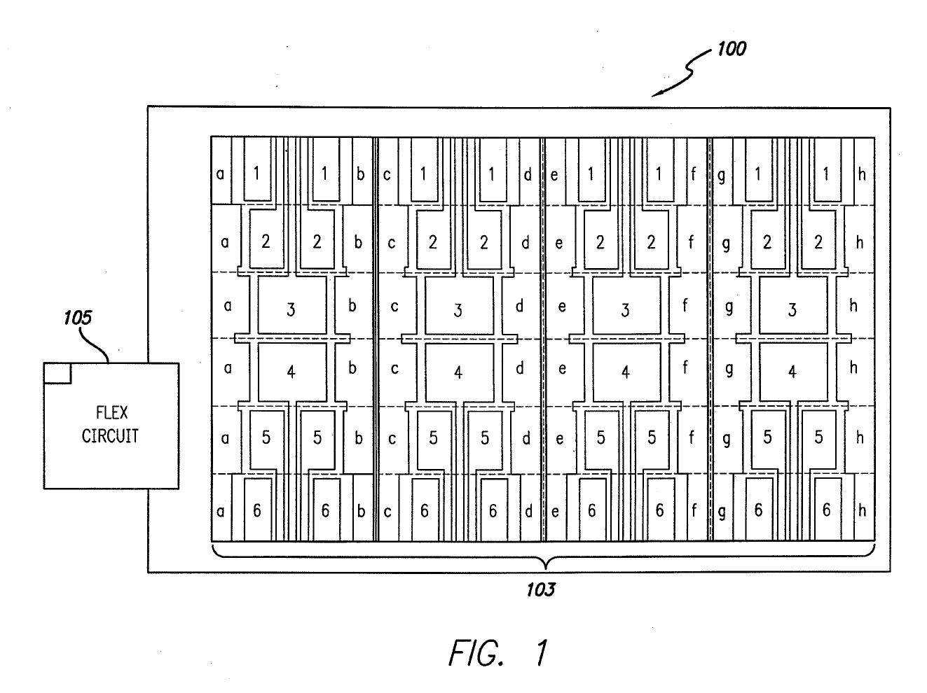

Conductive trace patterns can be formed from one or more layers of conductive material, such as ITO, a substantially transparent conductive material. In touch screen applications, conductive traces can be formed in a variety of patterns having different degrees of uniformity. Some touch screens, for example, can include a layer of conductive traces formed as a relatively uniform pattern of evenly-spaced lines of constant width. By comparison, FIG. 1 shows a conductive trace pattern that appears relatively non-uniform, which may be more visually distracting than a more uniform pattern. FIG. 1 illustrates a partial view of an example touch screen 100, including an example conductive trace pattern 103. In this example, conductive trace pattern 103 is a layer of ITO patterned to form eight columns (labeled a through h) and six rows (labeled 1 through 6), although it should be understood that any number of columns and rows can be employed. In the example of FIG. 1, one side of each column includes staggered edges and notches designed to create separate sections in each column. Each of rows 1 through 6 is formed from a plurality of distinct patches of ITO. For example, FIG. 1 illustrates the patches for rows 1-3 are arranged in inverted pyramid configurations between columns a and b, c and d, e and f, and g and h, while the patches for rows 4-6 are arranged in upright pyramid configurations between columns a and b, c and d, e and f, and g and h. Conductive trace pattern 103 includes thin traces of ITO running from some of the row patches to metal traces (not shown) in a border area of the touch screen. This can allow the patches in a particular row to be electrically connected together. The metal traces in the border area can be routed to a small area on one side of touch screen 100 and connected to a flex circuit 105 to allow a touch sensing operation, e.g., sending electrical drive signals and receiving electrical sense signals through the rows and columns of conductive trace pattern 103.

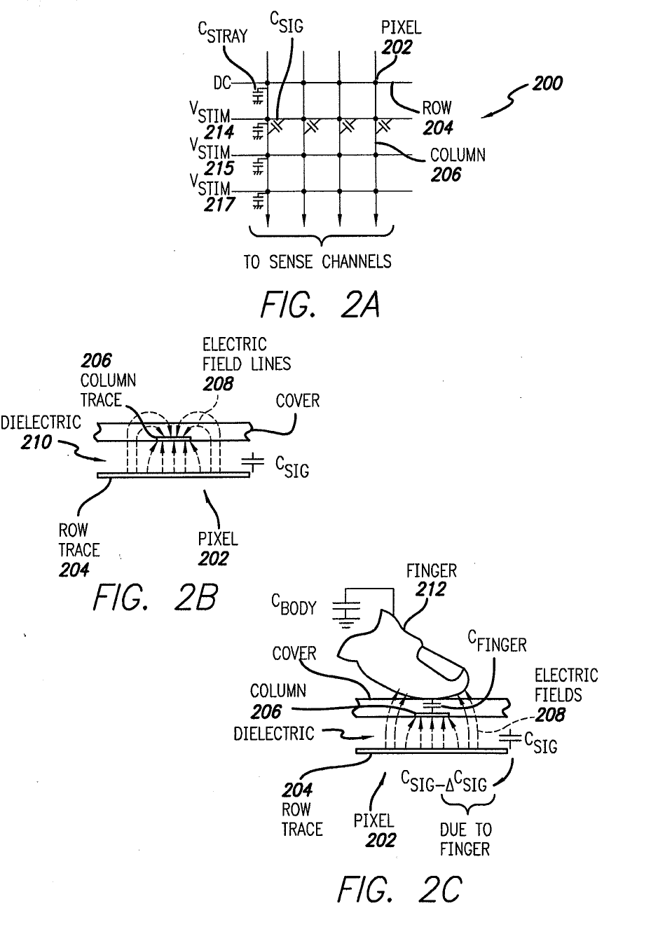

FIG. 2a illustrates an example mutual capacitance touch sensor panel 200 according to embodiments of the invention. FIG. 2a indicates the presence of a stray capacitance Cstray at each pixel 202 located at the intersection of a row 204 and a column 206 trace (although Cstray for only one column is illustrated in FIG. 2a for purposes of simplifying the figure). In the example of FIG. 2a, AC stimuli Vstim 214, Vstim 215 and Vstim 217 can be applied to several rows, while other rows can be connected to DC. Vstim 214, Vstim 215 and Vstim 217 can be, for example, signals having the same or different frequencies and different phases. Each stimulation signal on a row can cause a charge Qsig=Csig×Vstim to be injected into the columns through the mutual capacitance present at the affected pixels. A change in the injected charge (Qsig_sense) can be detected when a finger, palm or other object is present at one or more of the affected pixels. Vstim signals 214, 215 and 217 can include one or more bursts of sine waves. Note that although FIG. 2a illustrates rows 204 and columns 206 as being substantially perpendicular, they need not be so aligned, as described above. As described above, each column 206 can be connected to a sense channel.

FIG. 2b is a side view of example pixel 202 in a steady-state (no-touch) condition according to embodiments of the invention. In FIG. 2b, an electric field of electric field lines 208 of the mutual capacitance between column 206 and row 204 traces or electrodes separated by dielectric 210 is shown.

FIG. 2c is a side view of example pixel 202 in a dynamic (touch) condition. In FIG. 2c, finger 212 has been placed near pixel 202. Finger 212 is a low-impedance object at signal frequencies, and has an AC capacitance Cfinger from the column trace 204 to the body. The body has a self-capacitance to ground Cbody of about 200 pF, where Cbody is much larger than Cfinger. If finger 212 blocks some electric field lines 208 between the row and column electrodes (those fringing fields that exit the dielectric and pass through the air above the row electrode), those electric field lines are shunted to ground through the capacitance path inherent in the finger and the body, and as a result, the steady state signal capacitance Csig is reduced by ΔCsig. In other words, the combined body and finger capacitance act to reduce Csig by an amount ΔCsig (which can also be referred to herein as Csig_sense), and can act as a shunt or dynamic return path to ground, blocking some of the electric fields as resulting in a reduced net signal capacitance. The signal capacitance at the pixel becomes Csig-ΔCsig, where Csig represents the static (no touch) component and ΔCsig represents the dynamic (touch) component. Note that Csig-ΔCsig may always be nonzero due to the inability of a finger, palm or other object to block all electric fields, especially those electric fields that remain entirely within the dielectric material. In addition, it should be understood that as a finger is pushed harder or more completely onto the multi-touch panel, the finger can tend to flatten, blocking more and more of the electric fields, and thus ΔCsig can be variable and representative of how completely the finger is pushing down on the panel (i.e. a range from “no-touch” to “full-touch”).

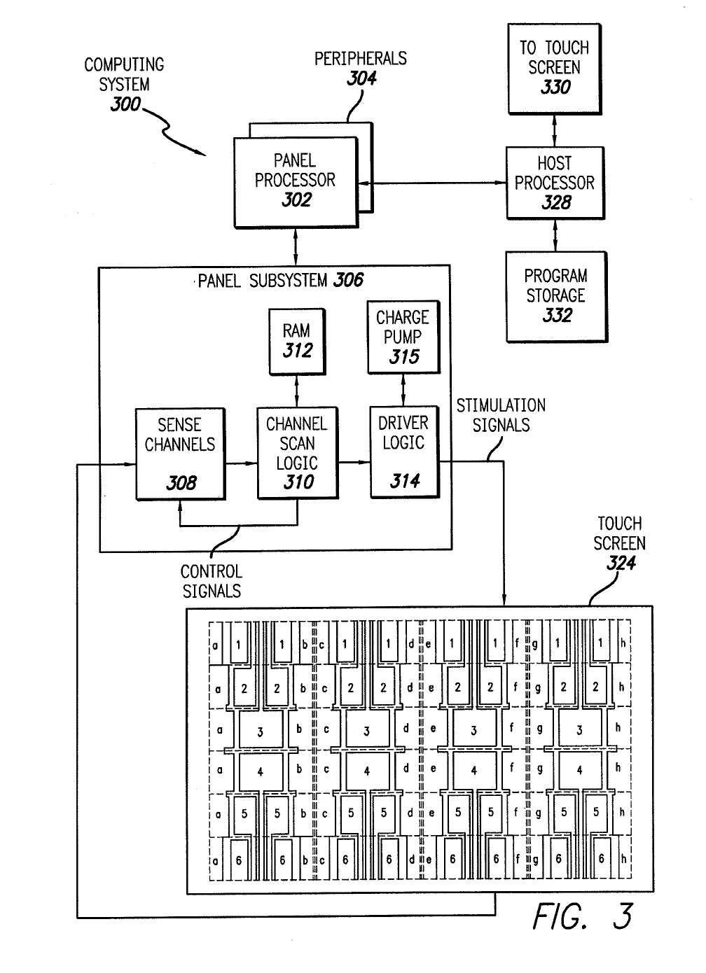

FIG. 3 illustrates example computing system 300 that can include one or more of the embodiments of the invention described above. Computing system 300 can include one or more panel processors 302 and peripherals 304, and panel subsystem 306. Peripherals 304 can include, but are not limited to, random access memory (RAM) or other types of memory or storage, watchdog timers and the like. Panel subsystem 306 can include, but is not limited to, one or more sense channels 308, channel scan logic 310 and driver logic 314. Channel scan logic 310 can access RAM 312, autonomously read data from the sense channels and provide control for the sense channels. In addition, channel scan logic 310 can control driver logic 314 to generate stimulation signals 316 at various frequencies and phases that can be selectively applied to drive lines of touch sensor panel 324. In some embodiments, panel subsystem 306, panel processor 302 and peripherals 304 can be integrated into a single application specific integrated circuit (ASIC).

Touch sensor panel 324 can include a capacitive sensing medium having a plurality of drive lines and a plurality of sense lines, although other sensing media can also be used. Each intersection of drive and sense lines can represent a capacitive sensing node and can be viewed as picture element (pixel) 326, which can be particularly useful when touch sensor panel 324 is viewed as capturing an “image” of touch. (In other words, after panel subsystem 306 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) Each sense line of touch sensor panel 324 can drive sense channel 308 (also referred to herein as an event detection and demodulation circuit) in panel subsystem 306. Touch sensor panel 324 can be integrated with a display device 330. When these two elements are integrated, it is preferred that the conductive trace patterns of the touch sensor panel be hidden from the user's perception.

However, electrical signal requirements of some touch screens can place constraints on the design of the conductive trace patterns. For example, some touch screens can require that the resistivity of a conductive trace pattern is below a certain threshold value. This can place a lower limit on the thickness of the conductive trace pattern because the resistivity of a conductive layer, such as an ITO layer, is inversely proportional to the thickness of the layer. The maximum resistivity limit in some touch screens can require the conductive trace pattern layer to be a minimum of 200 ångstroms (Å) thick, for example. As the thickness of the conductive trace pattern layer increases, the layer becomes more visible. At a thickness of 200 Å, for example, a typical layer of ITO patterned for a touch screen is visible to most users.

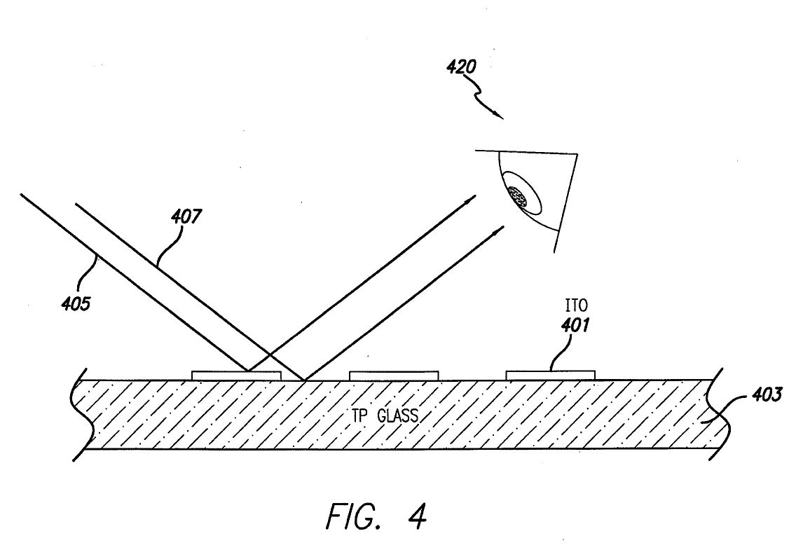

FIG. 4 shows a side view of an example conductive trace layer of patterned ITO 401 formed on a touch panel (TP) glass substrate 403. The index of refraction of glass is approximately 1.5. The index of refraction of ITO depends on the quality of the ITO, and can range from 1.6-1.7 for high-quality ITO to 1.9-2.1 for low-quality ITO. The visibility of the layers is a function of the layers' indices of reflection (R), which are proportional to the layers' indices of refraction. FIG. 4 illustrates two incident light rays, 405 and 407. Light ray 405 is reflected by ITO layer 401 with a reflectance of R₁, and light ray 407 is reflected by glass 403 with a reflectance of R₂. For the sake of clarity, each reflectance in the figures is illustrated using a single ray of light reflected by a single surface (i.e., interface between two different materials); however, one skilled in the art will recognize that reflectance can actually result from the interference of light rays reflected from other surfaces above and/or below the single surface illustrated in the figures.

Reflected light rays 405 and 407 are viewed by a user 420. Because patterned ITO layer 401 and glass substrate 403 have different indices of refraction (and hence, R₁≠R₂), light reflected by each surface appears different to user 420. In other words, patterned ITO layer 401 is visible in relation to glass substrate 403. As the difference between the indices of refraction increases, patterned ITO layer 401 becomes more visible. Low-quality ITO, for example, may be more visible than high-quality ITO in the above example. The absolute value of the difference between R₁ and R₂ is delta R (i.e., ¦/ R₁-R₂¦=ΔR). Reducing ΔR can reduce the visibility of patterned ITO layer 401, which may result in a more visually appealing touch screen.

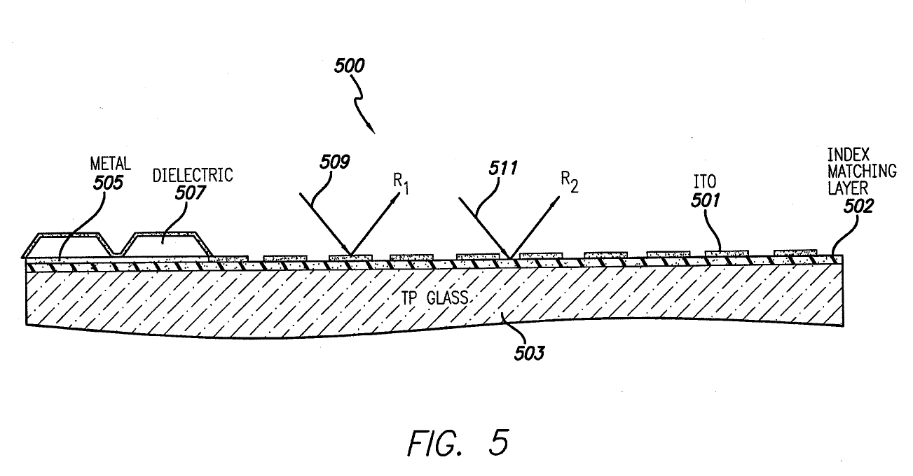

FIG. 5 illustrates an example method of reducing the visibility of a patterned ITO layer and improving an optical uniformity of a touch screen according to embodiments of the invention. FIG. 5 is a cross-section view of a portion of a touch screen stackup 500, including a patterned ITO layer 501 and a TP glass layer 503. Other structures of the touch screen are shown, including a metal layer 505 and a dielectric layer 507. Touch screen stackup 500 also includes an index matching layer 502 between and abutting patterned ITO layer 501 and glass layer 503. Stackup 500 can be formed, for example, by spin coating, slit coating, etc., a suitable inorganic or organic material onto glass layer 503 to form index matching layer 502, depositing ITO onto the index matching layer, and patterning the ITO to form patterned ITO layer 501.

FIG. 5 also shows two incident light rays, 509 and 511. Light ray 509 is reflected by ITO layer 501 with a reflectance of R₁, and light ray 511 is reflected by index matching layer 502 with a reflectance of R₂. The index of refraction of index matching layer 502 can be tuned to reduce the visibility of patterned ITO layer 501. For example, the index of refraction of index matching layer 502 can be tuned to be higher than the upper range of ITO refraction values. In other words, an index of refraction greater than approximately 2.1 could be chosen for index matching layer 502. Thus, index matching layer 502 can form part of a plurality of layers having a decreasing gradient of index of refraction values, with the index matching layer having a higher index of refraction than patterned ITO layer 501, which has a higher index of refraction than upper layers including, for example, a glass cover (not shown).

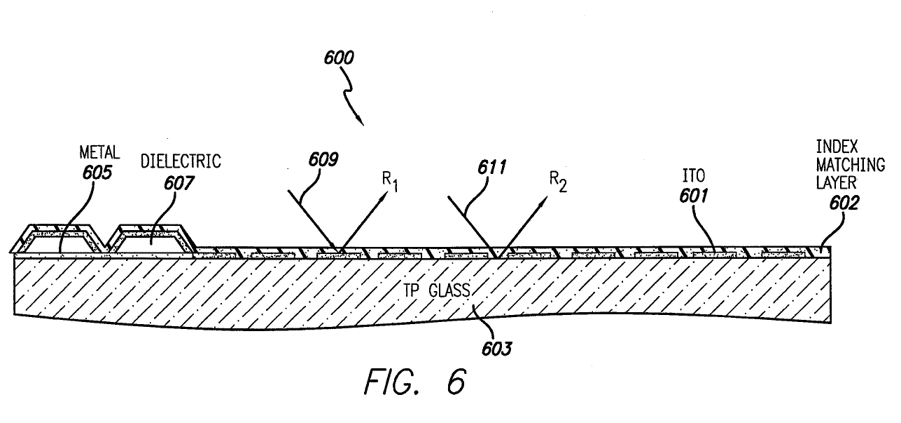

FIG. 6 illustrates another example method of reducing the visibility of a patterned ITO layer and improving an optical uniformity of a touch screen according to embodiments of the invention. FIG. 6 is a cross-section view of a portion of a touch screen stackup 600, including a patterned ITO layer 601 abutting a TP glass layer 603. Other structures of the touch screen are shown, including a metal layer 605 and a dielectric layer 607. Touch screen stackup 600 also includes an index matching layer 602 formed on top of and abutting patterned ITO layer 601. Stackup 600 can be formed, for example, by depositing ITO onto glass layer 603, patterning the ITO to form patterned ITO layer 601, and spin coating, slit coating, etc., a suitable inorganic or organic material to form index matching layer 602 over the patterned ITO layer and the glass layer.

FIG. 6 also shows two incident light rays, 609 and 611. In one approach, the indices of refraction of patterned ITO layer 601 and index matching layer 602 are closely matched. In this example, light ray 609 passes through the interface of the two layers with little or no reflection, and is reflected by an area of glass layer 603 with a reflectance of R₁. Light ray 611 is shown passing through index matching layer 602 and being reflected by glass layer 603 with a reflectance of R₂. Because indices of refraction of index matching layer 602 and patterned ITO layer 601 are closely matched, R₁ closely matches R₂, and ΔR can be reduced or minimized. This approach may be well-suited to applications in which the quality of the ITO of layer 601, and hence the index of refraction, is known during the design phase and remains relatively constant from batch to batch.

In another approach, the index of refraction of index matching layer 602 can be tuned to be between ITO refraction values and the index of refraction of layers above the matching layer 602. In other words, an index of refraction between 1.55 and 1.75 could be chosen for index matching layer 602. Thus, index matching layer 602 can form part of a plurality of layers having a decreasing gradient of index of refraction values, with the index matching layer having a lower index of refraction than patterned ITO layer 601, and a higher index of refraction than upper layers including, for example, a glass cover (not shown). This approach may be suited to applications in which the quality of the ITO of layer 602 is not known prior to the design phase or when the quality, and hence the index of refraction, of the ITO can vary from batch to batch.

Index matching layer 602 can be designed to serve as a passivation layer, in addition to its index matching function. In particular, materials that may be used to provide both index matching and passivation in layer 602 include, for example, nanoparticle-embedded organic polymers and polymerized siloxanes with high molecular-weight organic functional groups.

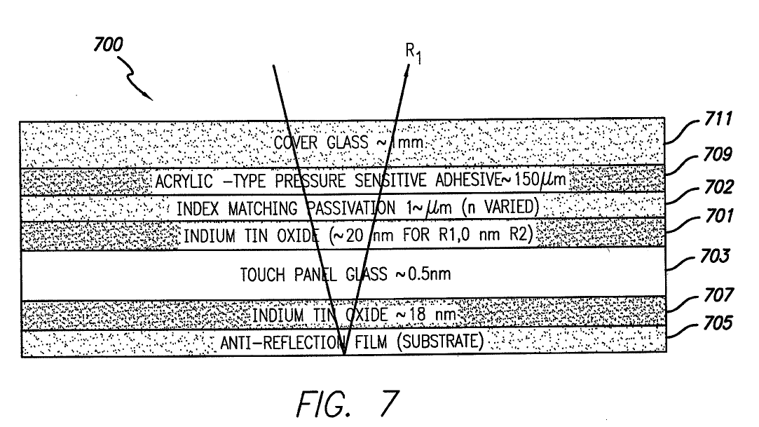

FIG. 7 shows an example computer simulation model 700 directed to the embodiment illustrated in FIG. 6. Simulation model 700 includes simulated layers for a TP glass 703, a patterned ITO layer 701, and an index-matching passivation layer 702, which correspond to layers 603, 601, and 602, respectively, of FIG. 6. FIG. 7 also includes simulated layers for an anti-reflection (AR) film 705, an ITO layer 707, an acrylic-type pressure sensitive adhesive (PSA) 709, and a cover glass 711.

Computer simulations were performed on simulation model 700 to determine ΔR values between areas with patterned ITO (20 nm thick) and areas without the patterned ITO (0 nm thick). The AR values were determined over a range of indices of refraction of the index-matching passivation layer. The simulations were performed for both a low-temperature ITO and a high temperature ITO. The results are shown in the following table:

TABLE 1
Simulation Results for Low Temperature and
High Temperature patterned ITO.

| | Passivation | | | |
|---|---|---|---|---|
| ITO | index of | R₁ (photopic | R₂ (photopic | ΔR = |
| process | refraction | reflectance %) | reflectance %) | R₁ − R₂ |
| low temp. | 1.50 | 6.98 | 5.62 | 1.36 |
| (typical) | 1.55 | 7.18 | 6.06 | 1.12 |
| | 1.60 | 7.65 | 6.81 | 0.84 |
| | 1.65 | 7.99 | 7.24 | 0.75 |
| | 1.70 | 8.00 | 7.40 | 0.60 |
| | 1.75 | 7.91 | 7.55 | 0.36 |
| high temp. | 1.50 | 6.27 | 5.30 | 0.97 |
| (typical) | 1.55 | 6.48 | 5.66 | 0.82 |
| | 1.60 | 6.97 | 6.35 | 0.62 |
| | 1.65 | 7.33 | 6.79 | 0.54 |
| | 1.70 | 7.42 | 7.00 | 0.42 |
| | 1.75 | 7.40 | 7.22 | 0.18 |

As shown in Table 1, by adjusting the index of refraction of the index matching passivation layer, the ΔR value of the low temperature patterned ITO stackup can be reduced from 1.36 to at least 0.36, and the high temperature patterned ITO stackup can be reduced from 0.97 to at least 0.18. The reduction in AR value can reduce the visibility of the ITO pattern and can improve an optical uniformity of a touch screen.

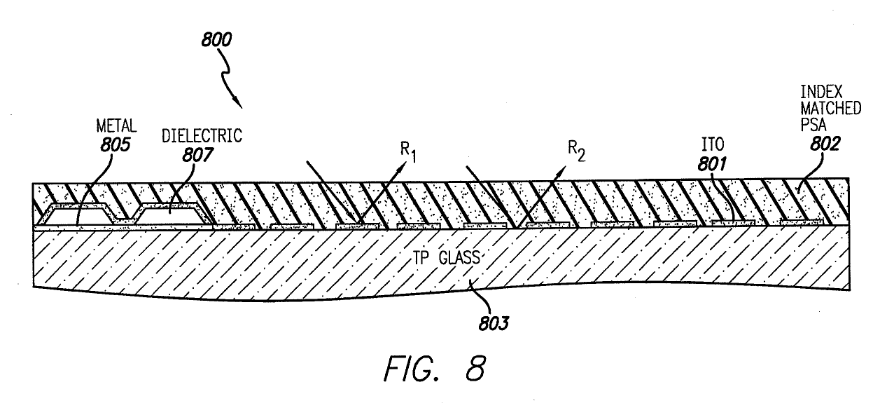

FIG. 8 illustrates another example method of reducing the visibility of a patterned ITO layer and improving an optical uniformity of a touch screen according to embodiments of the invention. FIG. 8 is a cross-section view of a portion of a touch screen stackup 800, including a patterned ITO layer 801 and a TP glass layer 803. Other structures of the touch screen are shown, including a metal layer 805 and a dielectric layer 807. Touch screen stackup 800 also includes an index matching layer 802 formed on top of patterned ITO layer 801. The example embodiment of FIG. 8 is identical to the example embodiment of FIG. 6, with the exception of the thickness and material of the index matching layers. In the embodiment of FIG. 8, index matching layer 802 is formed of an adhesive material, such as a PSA. In this way, index matching layer 802 can be formed to serve the function of index matching as well as the further function of adhering the lower layers to, for example, a glass cover (not shown). This method of forming a dual-function index matching layer can potentially reduce the number of processing steps in manufacturing the touch screen, as well as potentially reduce the thickness of the stackup.

In other embodiments, even further functionality may be obtained by designing an index matching layer 802 that can perform the additional function of passivating the ITO layer. Thus, such an index matching layer could provide three functions: index matching; adhering; and passivating. Adhesive materials that may be used to provide index matching, adhesion, and passivation include, for example, Epo-Tek® OG127-4 epoxy, which is a high-index adhesive.

In one potential benefit of index matching according to embodiments of the invention, it may be possible to use a lower-quality ITO, and hence, reduce the cost of manufacturing a touch screen. Therefore, a manufacturer may be able to take advantage of the lower temperature limits and lower costs of employing a lower quality ITO, compensating for the lower quality ITO's higher index of refraction with the application of an index matching layer. Another potential benefit is a reduction in the thickness of the touch screen and reduction in cost when a single index matching layer is designed to perform multiple functions, such as passivation and adhesion. It should be noted that this invention is not limited to a single index matching layer with a specific index of refraction, but may also be accomplished though a plurality of layers or a combination of various materials with different indices of refraction to accomplish this effect. For example a polymerized siloxane with an index of refraction of approximately 1.7 in the visible spectrum could be capped with an adhesive with an index of refraction of approximately 1.6.

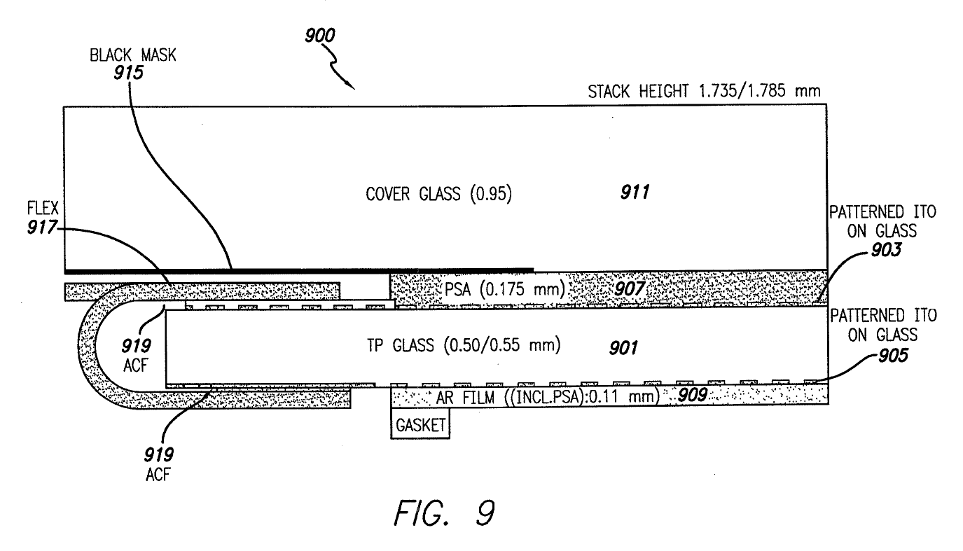

FIG. 9 is a cross-section view of an example double-sided ITO (DITO) stackup of a touch screen 900 according to embodiments of the invention. Touch screen 900 includes a TP glass 901 on which a first patterned ITO layer 903 is formed on a first surface, and a second patterned ITO layer 905 is formed on a second surface. An index matching PSA 907 is formed on first patterned ITO layer 903, and an AR film 909 is formed on second patterned ITO layer 905. AR film 909 could be, for example, an inorganic multilayer stack, a laminated organic layer, etc, with an index of refraction of approximately 1.35. A cover glass 911 is adhered to PSA 907. The index of refraction of PSA 907 can be, for example, approximately 1.6. Touch screen 900 also includes a black mask 915, a flex circuit 917, an anisotropic conductive film (ACF) 919, and an ACF 920.

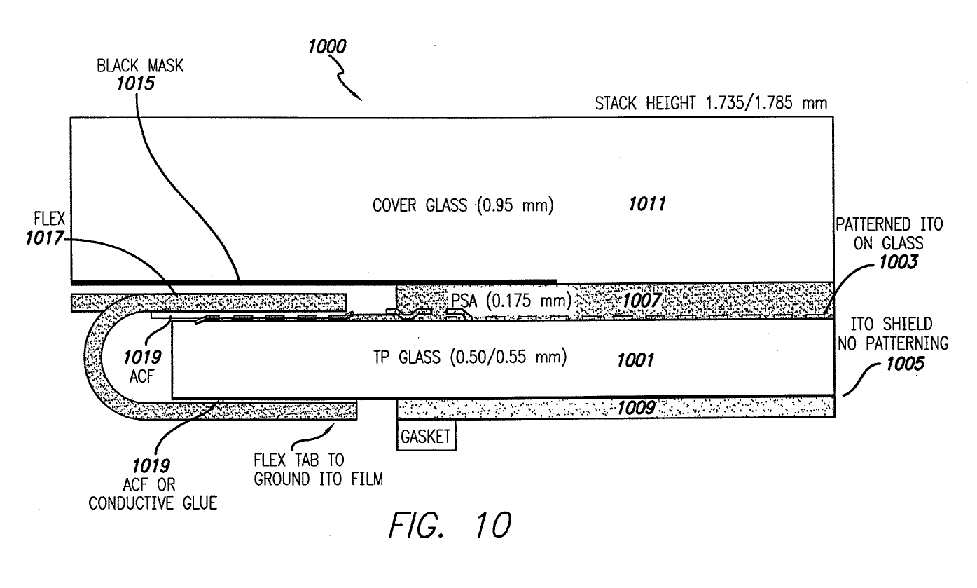

FIG. 10 is a cross-section view of an example single-layer ITO (SITO) stackup of a touch screen 1000 according to embodiments of the invention. Touch screen 1000 includes a TP glass 1001 on which a patterned ITO layer 1003 is formed on a first surface, and a non-patterned ITO layer 1005 is formed on a second surface. An index matching PSA 1007 is formed on patterned ITO layer 1003, and an AR film 1009 is formed on non-patterned ITO layer 1005. A cover glass 1011 is adhered to PSA 1007. AR film 1009 and PSA 1007 can be, for example, similar to AR film 909 and PSA 907, respectively. Touch screen 1000 also includes a black mask 1015, a flex circuit 1017, an ACF 1019, and an ACF 1021.

The index matching layers in the foregoing example embodiments may be formed by a variety of methods, such as spin coating, spin-on-glass (SOG), slit coating, etc. Furthermore, as one skilled in the art would understand in view of the present disclosure, other methods could be used to form the layers of the example stackups described above, and other stackup arrangements could be formed including, for example, stackups with additional layers around and/or between the layers described above.

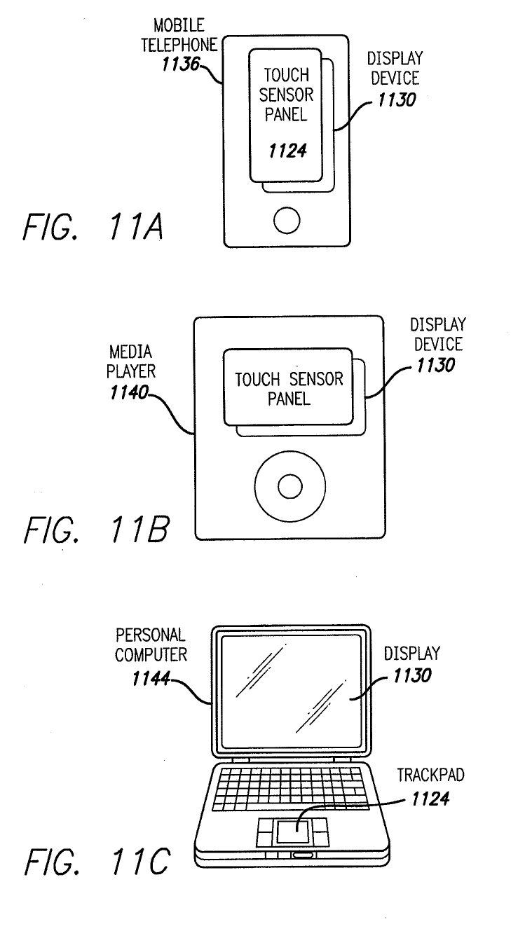

FIG. 11a illustrates example mobile telephone 1136 that can include touch sensor panel 1124 and display device 1130, the touch sensor panel including an index matching stackup according to embodiments of the invention.

FIG. 11b illustrates example digital media player 1140 that can include touch sensor panel 1124 and display device 1130, the touch sensor panel including an index matching stackup according to embodiments of the invention.

FIG. 11c illustrates example personal computer 1144 that can include touch sensor panel (trackpad) 1124 and display 1130, the touch sensor panel and/or display of the personal computer (in embodiments where the display is part of a touch screen) including an index matching stackup according to embodiments of the invention. The mobile telephone, media player and personal computer of FIGS. 11a, 11b and 11c can achieve improved overall utility through the reduction of visibility of conductive trace patterns on touch sensor panels according to embodiments of the invention.

Mobile telephone 1136, digital media player 1140, and personal computer 1144 can include, for example, a computing system such as computing system 300 of FIG. 3, which can be adapted to perform specific functions of the particular devices. Referring again to FIG. 3, computing system 300 can also include a host processor 328 for receiving outputs from panel processor 302 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 328 can also perform additional functions that may not be related to panel processing, and can be coupled to program storage 332 and display device 330 such as an LCD display for providing a UI to a user of the device. Display device 330 together with touch screen 324, when located partially or entirely under the touch screen, can form touch screen 318.

Note that one or more of the functions described above can be performed by firmware stored in memory (e.g. one of the peripherals 304 in FIG. 3) and executed by panel processor 302, or stored in program storage 332 and executed by host processor 328. The firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. An index matching stackup for a touch screen, the stackup comprising:
a substantially transparent substrate;
a substantially transparent conductive layer disposed over the substrate in a pattern; and
an index matching layer disposed over the conductive layer for improving an optical uniformity of the touch screen, wherein the index matching layer also passivates the conductive layer.

2. The index matching stackup of claim 1, wherein an index of refraction of the index matching layer is higher than an index of refraction of the conductive layer.

3. The index matching stackup of claim 1, further comprising:
a second substantially transparent layer disposed over the conductive layer, wherein the index matching layer is disposed between the conductive layer and the second substantially transparent layer, and an index of refraction of the index matching layer is between indices of refraction of the conductive layer and the second substantially transparent layer.

4. The index matching stackup of claim 3, wherein the index matching is an adhesive layer that the conductive layer to a second substantially transparent layer.

5. The index matching stackup of claim 1, wherein the index matching layer is an adhesive.

6. The index matching stackup of claim 1, wherein the conductive layer is Indium Tin Oxide.

7. The index matching stackup of claim 1, wherein the index matching layer includes one of i) a nanoparticle-embedded organic polymer and ii) a polymerized siloxane with high molecular-weight organic functional groups.

8. The index matching stackup of claim 1, the index matching stackup incorporated within a touch screen.

9. The index matching stackup of claim 8, the touch screen incorporated within a computing system.

10. A method of manufacturing an index matching stackup for a touch screen, the method comprising:
forming a substantially transparent conductive layer on a substantially transparent substrate;
patterning the conductive layer to form one of a plurality of drive lines and a plurality of sense lines; and
forming an index matching layer with the patterned conductive layer and the substrate for improving an optical uniformity of the touch screen.

11. The method of claim 10, further comprising forming the index matching layer between the substrate and the conductive layer.

12. The method of claim 10, further comprising forming the index matching layer over the substrate and the conductive layer.

13. The method of claim 10, further comprising selecting an index of refraction of the index matching layer to be substantially the same as an index of refraction of the conductive layer.

14. The method of claim 10, further comprising selecting an index of refracting of the index matching layer to be higher than an index of refraction of the conductive layer.

15. The method of claim 10, further comprising utilizing the index matching layer as an adhesive.

16. The method of claim 10, further comprising utilizing the index matching layer as a passivation layer.

17. The method of claim 10, wherein forming an index matching layer comprises:
spin coating an index matching material onto the patterned conductive layer.

18. The method of claim 10, wherein forming an index matching layer comprises:
slit coating an index matching material onto the patterned conductive layer.

19. An index matching stackup for a touch screen, the stackup comprising:
one or more layers of substantially transparent conductive material forming a plurality of drive lines and a plurality of sense lines; and
an index matching layer abutting one of the plurality of drive lines and the plurality of sense lines.

20. The index matching stackup of claim 19, wherein the index matching layer abuts both the plurality of drive lines and the plurality of sense lines.

21. The index matching stackup of claim 19, wherein an index of refraction of the index matching layer is substantially the same as an index of refraction of the abutting one of the plurality of drive lines and the plurality of sense lines.

22. The index matching stackup of claim 19, further comprising:
a substantially transparent layer abutting the index matching layer,
wherein the index matching layer is disposed between the substantially transparent layer and the abutting one of the plurality of drive lines and the plurality of sense lines, and an index of refraction of the index matching layer is between an index of refraction of the substantially transparent layer and an index of refraction of the abutting one of the plurality of drive lines and the plurality of sense lines.

23. The index matching stackup of claim 22, wherein the substantially transparent layer is a cover glass of the touch screen.

24. The index matching stackup of claim 19, wherein the conductive layer is Indium Tin Oxide.

25. The index matching stackup of claim 19, further comprising:
a substantially transparent substrate disposed between the plurality of drive lines and the plurality of sense lines.

26. The index matching stackup of claim 19, wherein the plurality of drive lines and the plurality of sense lines are formed of a single layer of the substantially transparent conductive material.

27. The index matching stackup of claim 19, further comprising:
an additional layer,
wherein the index matching layer is formed of an adhesive material that adheres the additional layer to the conductive layer.

28. The index matching stackup of claim 27, wherein the index matching layer is a pressure sensitive adhesive.

29. The index matching stackup of claim 19, the index matching stackup incorporated within a touch screen.

30. The index matching stackup of claim 29, the touch screen incorporated within a computing system.

31. A method of manufacturing a touch screen, the method comprising:
forming an index matching layer on a substantially transparent substrate;
forming a substantially conductive layer on the index matching layer; and
patterning the conductive layer to form one of a plurality of drive lines and plurality of sense lines.

32. The method of manufacturing of claim 31, wherein forming an index matching layer comprises:
spin coating an index matching material onto the substrate.

33. The method of manufacturing of claim 31, wherein forming an index matching layer comprises:
slit coating an index matching material onto the substrate.

34. An index matching stackup for a touch screen, the stackup comprising:
a substrate;
a substantially transparent conductive layer formed in a pattern on the substrate; and
a pressure sensitive adhesive that matches an index of refraction of the conductive layer to reduce a visibility of the pattern.

35. The index matching stackup of claim 34, the index matching stackup incorporated within a touch screen.

36. The index matching stackup of claim 35, the touch screen incorporated within a computing system.

37. A mobile telephone including an index matching stackup comprising:
a substantially transparent substrate;
a substantially transparent conductive layer disposed over the substrate in a pattern; and
an index matching layer disposed over the conductive layer for improving an optical uniformity of the touch screen, wherein the index matching layer also passivates the conductive layer.

38. A digital media player including an index matching stackup comprising:
a substantially transparent substrate;
a substantially transparent conductive layer disposed over the substrate in a pattern; and
an index matching layer disposed over the conductive layer for improving an optical uniformity of the touch screen, wherein the index matching layer also passivates the conductive layer.

39. A personal computer including an index matching stackup comprising:
a substantially transparent substrate;
a substantially transparent conductive layer disposed over the substrate in a pattern; and
an index matching layer disposed over the conductive layer for improving an optical uniformity of the touch screen, wherein the index matching layer also passivates the conductive layer.
